(19) United States
(12) Patent Application Publication
(10) Pub. No.: US 2022/0183302 A1
(43) Pub. Date: Jun. 16, 2022

(54) AGENT FOR CONTROLLING PESTS SUCH AS RODENTS

(71) Applicant: UK3M GREEN RODENTICIDE GMBH, Meran (IT)

(72) Inventor: Klaus GASSER, Gargazon (IT)

(73) Assignee: UK3M GREEN RODENTICIDE GMBH, Meran (IT)

(21) Appl. No.: 17/599,844

(22) PCT Filed: Mar. 26, 2020
(86) PCT No.: PCT/EP2020/058522

§ 371 Date: Sep. 29, 2021

(30) Foreign Application Priority Data
Apr. 8, 2019 (AT) A50305/2019

(51) Int. Cl. A01N 65/16; A01N 25/08; A01P 11/00

(52) U.S. Cl. CPC A01N 65/16; A01P 11/00; A01N 25/08

(57) ABSTRACT

The invention relates to agents for controlling pests, in particular rodents, such as mice, wherein the agent contains as an active substance, a grayonotoxin or a mixture of grayanotoxins and the active substance is present in or on plant tissue as an active substance carrier. The invention also relates to the use of plant tissue having a content of grayanotoxins as rodenticides and/or for driving away rodents.

### CROSS-REFERENCE TO RELATED APPLICATIONS

This application is the National Stage of International Patent Application No. PCT/EP2020/058522 filed on Mar. 26, 2020, which claims priority from Austrian Patent Application No. A50305/2019 filed on Apr. 8, 2019, both of which are herein incorporated by reference herein in their entireties.

### BACKGROUND

### 1. Field

The invention relates to an agent for controlling pests, in particular rodents, such as mice. The invention further relates to the use and application of the agent for pest control and to a device for applying this agent with a bait box.

### 2. State of the Art

Rodents, such as mice and rats, are synanthropes of humans and forage directly in food storage places, for example. Further, rodents also preferably stay in areas used for food production, where they eat the crops or damage roots and tubers of the plants as a result of living underground. In Indonesia, 17% of the rice harvest is lost due to rodents, for example. All of this means huge material damage as well as collateral damage, such as damage to insulating materials, power supply lines and water pipes, etc.

In addition to the material damage caused by the rodents, some species are also known as transmitters of diseases, thus being a threat to humans. Through bites, pasteurellosis and rabies can be transmitted, among others. The rodents' faeces can lead to the transmission of salmonellosis and leptospirosis, as well as haemorrhagic fever. Probably the best-known diseases are those transmitted by fleas parasitizing on rodents, such as murine typhus and the plague.

Therefore, the control or at least containment of the rodent population is an objective of pest control and also of plant protection and represents an important element of hygiene provision.

Mouse control agents with bait have been known for a long time. Widely used active substances are coumarins, which are anticoagulants from the group of vitamin K antagonists that inhibit blood clotting. They have the advantage that the toxic effect does not occur immediately after ingestion, but only at a later time when the rodents being controlled retreat; therefore, they do not die next to the bait.

The responsible authorities now assess anticoagulants as rodenticides very critically. On the one hand, resistance can develop in the rodent population being controlled. On the other hand, environmentally hazardous properties may occur, such as persistence or bioaccumulation. Furthermore, internal bleeding can cause severe animal suffering lasting several days. Moreover, these active substances do not only affect rodents, but also predators such as owls, buzzards, golden eagles, foxes and polecats, which prey on mice. Furthermore, seed- and grain-eating birds may also be affected if they eat this bait directly.

### SUMMARY

It is an object of the present invention to provide an agent and a device for controlling rodents, such as mice, which is derived from nature, is biological, is definitely effective, and causes limited or no environmental harm. A further objective is to make the agent easy to use and inexpensive.

Furthermore, the agent and the device for its application should be as close to nature as possible, i.e. as far as possible without chemically artificially produced active substances. Furthermore, the agent should be readily able to be stored and sold for the period of time necessary in practice. A farm worker should be able to apply it. The agent according to the invention is characterized in that the agent contains a grayanotoxin or a mixture of grayanotoxins as an active substance and in that the active substance is provided in or on plant tissue as an active substance carrier.

It is optionally provided that the plant tissue comes from a plant belonging to the Ericaceae family, in particular the genus Rhododendron.

It is optionally provided that parts capable of germination of a Rhododendron plant, e.g. roots, stems, leaves and/or flowers, are provided as plant tissue.

It is optionally provided that the plant tissue naturally contains the active sub stance.

It is optionally provided that the plant tissue is enriched with grayanotoxin as the active substance.

It is optionally provided that the content of the grayanotoxin or the mixture of grayanotoxins in the plant tissue is at least 0.0005 wt. %, preferably between 0.0005 wt. % and 2 wt. %.

It is optionally provided that the agent can be introduced into the rodents' tunnels.

It is optionally provided that the agent can be planted as a seedling with the capacity to grow in the tunnels or near the tunnels of the rodents.

It is optionally provided that the agent is provided as a plant tissue in the form of seedlings and/or plant parts with the capacity to grow in a container, which contains a plant substrate allowing growth and allows air and light to enter.

It is optionally provided that the container has one or more entrance openings for the access of rodents. It is optionally provided that at least one entrance opening is covered by a removable closure.

It is optionally provided that the container has a waterproof bottom tray, which is closed from above by a lid or a foil, and wherein the container including its contents can be stacked for transport.

It is optionally provided that the container and the lid can be decomposed in the ground by humidity, in order to allow the plant tissue to form roots and grow.

It is optionally provided that at least part of the plant tissue is dead plant tissue, which has lost its capacity to grow.

The invention further relates to the use of plant tissue containing grayanotoxins as a rodenticide and/or for driving away rodents.

It is optionally provided that the plant tissue is provided as an agent having the features according to the invention in a container.

Exemplary embodiments of the present invention are described in greater detail below with reference to the drawings which are partially schematic diagrams. Further features can be found in the claims and the description.

### BRIEF DESCRIPTION OF THE DRAWINGS

FIGS. 1 and 2 show oblique views of two different embodiments of the invention.

### DETAILED DESCRIPTION

The pieces of plant tissues 1, which contain the active substance, in the form of small plantlets or cuttings of the plant genus Rhododendron are stuck or rooted in a growth substrate 2. The substrate 2 is located at the bottom of a largely transparent container 3, which is preferably made of transparent plastic. At the top, the container 3 is closed by a lid 4. The lid 4 may be removable or, for example, have the form of a foil bonded to the edges of the container 3. The lid 4 has air holes 5. In the form shown, the agent may also be transported and stacked over a prolonged period of time. As a result of the air holes 5 and the exposure to light through the transparent container 3, the plant can grow and survive.

There are several possibilities for its application as a pesticide, especially as a rodenticide. On the one hand, the plantlets or plant parts 1 can be removed from the packaging and inserted into or planted in the rodents' tunnels.

On the other hand, the container 3 may be used as a mousetrap. For this purpose, entrance openings 6 for mice are indicated as one possibility, which are closed for transport, and on site the closure 7, for example in the form of an adhesive foil, can be pulled off and the agent placed in the vicinity of the rodent tunnels.

FIG. 2 shows a narrower embodiment of the agent for controlling pests, wherein the cross-section or width of the container 3 is chosen such that the container 3 including its contents can be inserted into a possibly widened tunnel of the rodents.

Advantageously, the container 3 may be waterproof, at least in the lower region, so that the moist growth substrate 2 cannot soak the container 3. The moist soil should not destroy the contents immediately.

However, it may be provided that the container 3 is decomposed by moisture from the outside after a certain period of exposure, so that the sprouting plant parts 1 of the Rhododendron can form roots into the surrounding soil, thus allowing the Rhododendron to form roots and grow.

The plant growth substrate 2 may be a moist storage material, such as soil or conventional available plant substrates. The growth substrate 2 may be provided with nutrients required for growth.

Alternatively, mere water or moisture may be provided in a water reservoir to prevent desiccation of inserted plant parts 1. The plant parts 1 are preferably those that have an increased content of the active substance, such as the flowers.

The interior of the containers 3 may also contain, for example, further attractants, which attract the rodents so that they approach the plant parts 1 in the container 3.

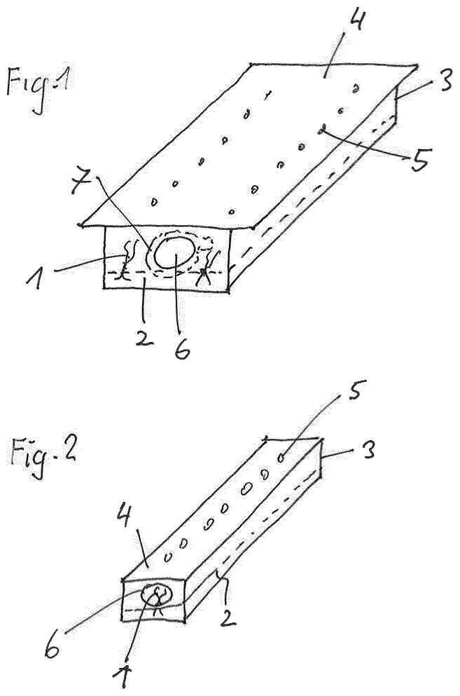

The embodiment according to FIG. 1 is only to be seen as an example. Two or more rows of plant tissue 1 may be arranged, and the number of air holes 5 may also be adapted to the requirements. An entrance opening 6 for mice can be arranged in the end face, as shown in FIG. 1, but also in the form of gaps in the long side of the container 3 or also in the lid 4. It is essential that the rodent has easy access to the plant tissue 1. Preferably, the container 3 with the lid 4 is so sturdy that the contents are protected for transport and that stacking is possible.

The embodiment according to FIG. 2 is also to be seen as purely schematic. Such a narrow housing can either contain one piece of plant tissue 1 or a number of pieces of tissue. The entrance opening 6 for mice is preferably arranged in one of the narrow end faces, as shown in the drawing, so that the rodent can easily enter the interior of the container 3 to eat the pieces of plant tissue there.

A preferred application of the embodiment according to FIG. 2 is to push the container 3 with contents into a rodent tunnel in such a way that the entrance opening 6 is aligned with the tunnel. Since rodents have a tendency to keep the tunnels clear, the rodents will readily enter the container 3 and eat the grayanotoxin-laden pieces of tissue there.

Exemplary dimensions for the container 3 according to FIG. 2 are: Length 20 cm, width 6 cm, height 6 cm.

The plant tissues 1 used are suitable if they contain an active substance which is lethal for the rodent, wherein the grayanotoxins in particular are to be mentioned as a substance class. These active substances are contained in particular in suitable rhododendron species, of which the corresponding pieces of tissue 1 may be stored or planted in the container 3. In the context of the invention, it may also be advantageous to enrich the pieces of tissue 1 with the active substance, which may be done either by cultivating the corresponding plants, or by artificial addition, such as spraying or injection.

The containers 3 have the further advantage that, on the one hand, the pieces of tissue 1 loaded with the active substance are not freely accessible and that, on the other hand, the contents of the container 3 are protected. If the container 3 is made of a degradable material, it can, for example, decompose within one to two months and allow the plants to grow out of it.

### LIST OF REFERENCE SIGNS

1 Plant tissue
2 Growth substrate
3 Container
4 Lid
5 Air hole
6 Entrance opening for mice
7 Closure

1. An agent for controlling pests including an active substance comprising a grayanotoxin or a mixture of grayanotoxins, wherein the active substance is provided in or on plant tissue as an active substance carrier.

2. The agent according to claim 1, wherein the plant tissue comes from a plant belonging to the Ericaceae family.

3. The agent according to claim 2, wherein the plant tissue comprises parts capable of germination of a Rhododendron plant.

4. The agent according to claim 1, wherein the plant tissue naturally contains the active substance.

5. The agent according to claim 1, wherein that the plant tissue is enriched with grayanotoxin as the active substance.

6. The agent according to claim 1, wherein the content of the grayanotoxin or the mixture of grayanotoxins in the plant tissue is at least 0.0005 wt. %, preferably between 0.0005 wt. % and 2 wt. %.

7. The agent according to claim 1, wherein the agent is configured for introduction into the rodents' tunnels.

8. The agent according to claim 1, wherein the agent is planted as a seedling with the capacity to grow in the tunnels or near the tunnels of the rodents.

9. The agent according to claim 1, wherein the agent is provided as a plant tissue in the form of seedlings and/or plant parts with the capacity to grow in a container, wherein the container contains a plant substrate allowing growth and allows air and light to enter.

10. The agent according to claim 9, wherein the container has at least one entrance opening for the access of rodents.

11. The agent according to claim 10, wherein the at least one entrance opening is covered by a removable closure.

12. The agent according to claim 9, wherein the container has a waterproof bottom tray, which is closed from above by a lid or a foil, and wherein the container including its contents can be stacked for transport.

13. The agent according to claim 12, wherein the container and the lid can be decomposed in the ground by humidity, in order to allow the plant tissue to form roots and grow.

14. The agent according to claim 1, wherein at least part of the plant tissue is dead plant tissue, which has lost its capacity to grow.

15. A method for controlling rodents, comprising using an agent comprising plant tissue containing grayanotoxins as a rodenticide.

16. The method according to claim 15, wherein the agent includes the features of claim 1 contained in a container.

17. The agent according to claim 1, wherein the pests comprise rodents.

18. The agent according to claim 2, wherein the plant tissue comes from a plant belonging to the genus Rhododendron.

19. The agent according to claim 3, wherein the parts are selected from roots, stems, leaves and/or flowers.

20. A rodenticide containing an active substance comprising grayanotoxin or a mixture of grayanotoxins, wherein the rodenticide is provided as a plant tissue in the form of seedlings and/or plant parts with the capacity to grow in a container, wherein the container contains a plant substrate allowing growth and allows air and light to enter, wherein the container has at least one entrance opening one or more entrance openings for the access of rodents.
